(19) United States
(12) Patent Application Publication
(10) Pub. No.: US 2024/0420429 A1
(43) Pub. Date: Dec. 19, 2024

(54) INTERACTIVE ANCHORS IN AUGMENTED REALITY SCENE GRAPHS

(71) Applicant: InterDigital CE Patent Holdings, SAS, Paris (FR)

(72) Inventors: Vincent Alleaume, Pace (FR); Caroline Baillard, Saint Sulpice la Foret (FR); Patrice Hirtzlin, Betton (FR); Pierrick Jouet, Rennes (FR); Matthieu Fradet, Chanteloup (FR)

(21) Appl. No.: 18/698,598

(22) PCT Filed: Oct. 3, 2022
(86) PCT No.: PCT/EP2022/077469

§ 371 Date: Apr. 4, 2024

(30) Foreign Application Priority Data
Oct. 6, 2021 (EP) 21306409.0
Dec. 9, 2021 (EP) 21306731.7

(51) Int. Cl. G06T 19/00

(52) U.S. Cl. CPC G06T 19/006

(57) ABSTRACT

An augmented reality scene description format is provided comprising relationships between real and virtual objects and interactive triggering and processing of the augmented reality scene. An augmented reality system can read the scene description and run a corresponding augmented reality application. The scene description comprises a scene graph structuring descriptions of the real and virtual objects which may be linked to media content items. It also comprises anchors that describes triggers for performing actions on the media content items, on the scene description itself and/or on remote devices and services.

### 1. TECHNICAL FIELD

The present principles generally relate to the domain of augmented reality scene description and augmented reality rendering. The present document is also understood in the context of the formatting and the playing of augmented reality application when rendered on end-user devices such as mobile devices or Head-Mounted Displays (HMD).

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Augmented reality (AR) is a technology enabling interactive experiences where the real-world environment is enhanced by virtual content, which can be defined across multiple sensory modalities, including visual, auditory, haptic, etc. During runtime of the application, the virtual content (3D content or audio file for example) is rendered in real-time in a way which is consistent with the user context (environment, point of view, device, etc.). Scene graphs (such as the one proposed by Khronos/glTF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand. Dynamics of AR system using such scene graphs is embedded in AR applications dedicated to a given AR scene. In such applications, virtual content items may be changed or adapted, but the timing and the triggering of the AR content rendering belongs to the application itself and cannot be exported to another application.

There is a lack of an AR system that can take an AR scene description comprising links between real and virtual elements and a description of the dynamics of the AR experience to be rendered.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate a method for rendering an augmented reality scene for a user in a real environment. The method comprises:
obtaining a description of the augmented reality scene, the description comprising:
   a scene graph linking nodes; and
   anchors, an anchor being associated to at least a node of the scene graph and comprising:
      at least a trigger, a trigger being a description of at least a condition;
      a trigger being activated when its at least a condition is detected in the real environment;
      at least an action, an action being a description of a process to be performed by an augmented reality engine;
loading at least a part of media content items being linked to the nodes of the scene graph;
observing the augmented reality scene; and
on condition that at least a trigger of an anchor is activated, applying the at least an action of the anchor to the at least a node associated with the anchor.

The present principles also relate to an augmented reality rendering device comprising a memory associated with a processor configured to implement the method above.

The present principles also relate to a data stream representative of an augmented reality scene and comprising:
a description of the augmented reality scene, the description comprising:
   a scene graph linking nodes; and
   anchors, an anchor being associated to at least a node of the scene graph and comprising:
      at least a trigger, a trigger being a description of at least a condition;
      a trigger being activated when its at least a condition is detected in a real environment;
      at least an action, an action being a description of process to be performed by an augmented reality engine; and
media content items linked to nodes of the scene graph.

### 4. BRIEF DESCRIPTION OF DRAWINGS

The present disclosure will be better understood, and other specific features and advantages will emerge upon reading the following description, the description making reference to the annexed drawings wherein:

FIG. 1 shows an example augmented reality scene graph;

FIG. 2 shows a non-limitative example of an AR scene description, according to a non-limiting embodiment of the present principles;

FIG. 3 shows an example architecture of a device which may be configured to implement a method described in relation with FIGS. 5 and 6, according to a non-limiting embodiment of the present principles;

FIG. 4 shows an example of an embodiment of the syntax of a data stream encoding an augmented reality scene description according to the present principles;

FIG. 5 illustrates a method for rendering an augmented reality scene according to a first embodiment of the present principles;

FIG. 6 illustrates a method 60 for rendering an augmented reality scene according to a second embodiment of the present principles;

FIG. 7 shows an example scene description in a first format according to the present principles.

FIG. 8 shows another example scene description in the first format according to the present principles.

FIG. 9 shows an example scene description in a second format according to the present principles.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

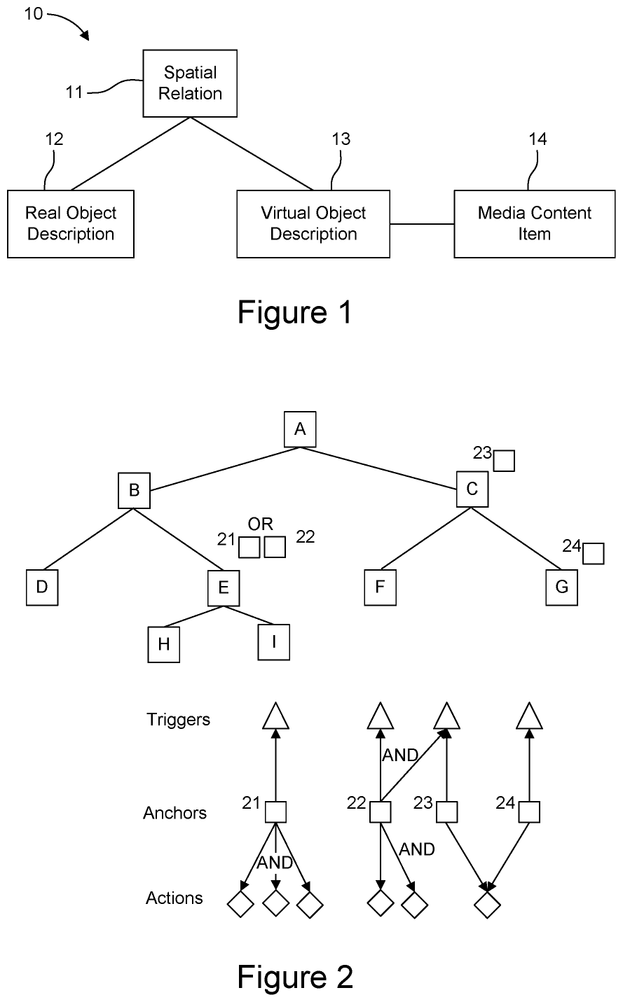

FIG. 1 shows an example augmented reality scene graph 10. In this example, the scene graph comprises a description of a real object 12, for example ‘plane horizontal surface’ (that can be a table or the floor or a plate) and a description of a virtual object 13, for example an animation of a walking character. Scene graph node 13 is associated with a media content item 14 that is the encoding of data required to render and display the walking character (for example as a textured animated 3D mesh). Scene graph 10 also comprise a node 11 that is a description of the spatial relation between the real object described in node 12 and the virtual object described in node 13. In this example, node 11 describes a spatial relation to make the character walk on the plane surface. When the AR application is started, media content item 14 is loaded, rendered and buffered to be displayed when triggered. As soon as a plane surface is detected in the real environment by sensors (a camera in the example of FIG. 1), the application displays the buffered media content item as described in node 11. Such a scene graph does not describe the timing and triggering of the AR application. The timing and triggering are a native step of the application. More complex triggering can be programmed, for instance, waiting for an action from the user. A different application, provided with scene graph 10, would not behave the same way as the AR experience timing and triggering may be different.

A node of a scene graph may also comprise no description and only play a role of a parent for child nodes.

AR application are various and may apply to different context and real environments. For example, in an industrial AR application, a virtual 3D content item (e.g. a piece A of an engine) is displayed when a reference object (piece B of an engine) is detected in the real environment by a camera rigged on a head mounted display device. The 3D content item is positioned in the real-world with a position and a scale defined relatively to the detected reference object.

In an AR application for interior design, a 3D model of a furniture is displayed when a given image from the catalog is detected in the input camera view. The 3D content is positioned in the real-world with a position and scale which is defined relatively to the detected reference image. In another application, some audio file might start playing when the user enters an area which is close to a church (being real or virtually rendered in the augmented real environment). In another example, an ad jingle file may be played when the user sees a can of a given soda in the real environment. In an outdoor gaming application, various virtual characters may appear, depending on the semantics of the scenery which is observed by the user. For example, birds characters are suitable for trees, so if the sensors of the AR device detect real objects described by a semantic label ‘tree’, birds can be added flying around the trees. In a companion application implemented by smart glasses, a car noise may be launched in the user's headset when a car is detected within the field of view of the user camera, in order to warn him of the potential danger; Furthermore, the sound may be spatialized in order to make it arrive from the direction where the car was detected.

FIG. 2 shows a non-limitative example of an AR scene description according to the present principles. A scene graph as described in relation to FIG. 1 is augmented with a set of anchors associated to nodes of the scene graph. Anchors are elements of the scene description specifying the relationships between the AR scene (multi-modal media) and the real world (environment and user). These anchors provide information when and/or under what conditions actions have to be performed. Actions may concern the loading of media content items, the rendering and playing of media content items or a modification of the scene description itself.

An anchor is associated with a node of the scene graph and comprises two information elements:
at least one trigger. A trigger describes a set of joint conditions, for example the detection of a given image, the detection of an object with a given semantics or given geometric properties, specific user interactions, user entering a given area of the real space, timer value reaching a specific value, etc. A trigger is activated when the described conditions are detected in the real and/or virtual environment are detected by the sensors of the AR system; and
a set of actions, which describe what happens to the part of the AR scene corresponding to the associated node when the at least one trigger is activated: upload, launch, stop, update, connect to server, notify, update scene graph, etc.

Thanks to these anchors specifying author-defined behaviors (triggers and actions), it is possible to precisely define when and how the nodes of an AR scene graph shall be processed by the presentation engine at runtime.

In the example of FIG. 2, a set of anchors is defined within the scene description. Any node or group of nodes of the scene graph may be associated with one or several anchors. When a node is associated with several anchors, an information in the node may indicate how the anchors triggers are handled (first met only, last met only, all met together). When the trigger of the anchor is activated, the actions performed on this node may affect the child nodes. If the child node has its own anchor, the actions of this anchor may prevent the child node to be affected by the actions of the anchor of its parent nodes (e.g. in case of relocation of a media content item). For example, nodes E is associated with anchors 21 and 22 (with an ‘OR’ combination). As being child of E, nodes H and I may be concerned by actions of anchors 21 and 22. For example, node C is associated with anchor 23. And so is node F as a child of node C. Node G is also a child of node C but is associated with anchor 24. In the example of FIG. 2, nodes A B and D are not associated with any anchor.

In the example of FIG. 2, anchor 21 comprises one trigger and three joint actions. Anchor 22 comprises two triggers with a ‘AND’ combination and two actions, for example a detection of a given object and a time range [1:05 pm to 1:15 pm] and two actions. The two actions are performed only if the given object is detected and if the current time is in the time range. Anchor 23 comprises one trigger that is the same than the second trigger of anchor 22: the time range [1:05 pm to 1:15 pm] and one action, for example play a bell sound in the headset described in node C (with left speaker of node F and right speaker of node G). In this example, a bell rings in both speakers of the headset from 1:05 pm to 1:15 pm. Anchor 24 has one trigger, for example the detection of a human being at the front door of the house by the front door camera, and one action that is the same than the action of anchor 23, that is playing a bell sound but only in the right speaker as described by node G which is associated with anchor 24.

### Triggers

A trigger specifies conditions for an action to take place. It can be based on environmental properties, user input or timers. It can also be conditioned to constraints like the type of rendering device or the user profile. There are several types of triggers.

An environment-based trigger is related to the user environment and relies on data captured by sensors during runtime. Environment-based triggers may, for example, be:
From visual sensors:
2D marker: detection of a given 2D image (described or referenced in the trigger);
3D marker: detection of a given 3D object (described or referenced in the trigger);
Visual signature: detection of a specific arrangement of feature points (for instance generated or provided by another user);
Geometric properties: verification of geometric properties (ex: vertical plane);
Semantic properties: detection of objects with semantic properties (ex: a face, a tree, etc.);
From audio sensors:
Audio marker: Detection of a specific noise (signal described or referenced in the trigger, or identifiable through audio feature extraction);
Audio properties: Detection of a type of noise, that type being characterizable by various means, such as semantic (ex: noise of a car) or periodicity (periodic beep) or other.
   Environment-based triggers may be activated by any sensor providing information on the real environment like temperature sensors, Inertial Measurement Units, GPS, hygrometry sensors, IR or UV light sensors, wind sensors, etc.

When the trigger relies on the detection of a particular item in the real world, a model or a semantic description of this particular item is described in or attached to the trigger. For example, a reference 2D image, a reference 3D mesh or a reference audio file are attached to the anchor in case of respectively a 2D marker, 3D marker or audio marker.

In case the item to detect is described by a semantic description (that may be a list of word tokens for example), the processing performs as following:

If the application processes an only virtual scene based on that scene graph (possibly updated from time to time by the application or by other means) like in a VR game application for instance, the semantic description is accurate enough to precisely identify virtual item(s) appearing in the scene graph during the application runtime.

If the application processes a Mixed reality application based on the scene graph (possibly updated from time to time by the application or other means), the semantic description is accurate enough to precisely identify item(s) appearing in the scene graph or in the real scene linked to that scene graph. For example, the application may rely on the scene graph for managing virtual objects placed in a real scene that the application has means to observe or analyze through relevant sensors (e.g. 2D camera or 3D sensors such a LiDAR).

When a matching item is detected (in the virtual or in the real world corresponding to the scene graph), the application transforms the corresponding graph location according to the detected item's location and orientation, to be able to finally anchor any linked node to that identified pose. Depending on the sensors or the method used to detect the matching real item, that transform may be performed according to different techniques. For instance, if the detection is based on 2D camera sensor and image-based detection of objects matching the semantic description, the transform processes the 2D object location in the 2D camera image, plus relative device (camera) position, to estimate pose of a node into the scene graph 3D space according to the detected item. In some cases, an additional transform is applied to provide the final matching relevant pose in the scene graph of a semantically matching real object, to provide a scene's pose centered on that object, or applying pose correction on some type of object. Indeed, providing pose for the center of a matching object may be useful if the object is big, for example. Or, providing a pose corrected for a matching object may be useful to get a anchoring pose-in orientation-different from the detected object. For example, an accurate semantic description of an item may be (not limited to) “Open Hand”, “Smiling Face”, “Red carpet”, “Game Board”, etc.

In case of multiple items matching the semantic description at the same moment, the application may (but is not limited to) decide to process the items following a built-in strategy, or, on a strategy based on metadata defined at the scene level or individually on specific nodes of the scene graph. For instance, possible strategies may consist in ignoring the multiple detection because the semantic description is not accurate/discriminative enough, or in processing every match by duplicating anchored node(s) to every matching item location (triggering some duplication of node(s) and possibly their child nodes in some example), or in considering some proximity criteria to select one of the matches, to be processed as the one and only match, and ignoring all the others. The different strategies may also be combined. The proximity criteria may be a distance between match location in the scene to another node of that scene (or to a user localized in the area of the corresponding graph scene).

A triggering event may be stable in time, or inversely could be transient. For instance, in the case of semantic description defining an anchor, a corresponding item could be observed for a limited period. For example, the application may first trigger the anchoring of related node(s) while the semantically matching item is detected and its pose is estimated, and may later reset the anchor to an unfulfilled criterion leading to a un-anchoring operation (the previously anchored node(s) returning to the default pose provided in the scene graph, as if never anchored), when the matching item is no longer observed.

A marker (2D, 3D, or semantic description) may correspond to a moving item, leading to the application to manage this feature according to various ways. For example, when detected, the marker pose is estimated once, and the anchor is applied to nodes for this once-estimated location (even if marker pose or location changes). Or, when detected, and updated by the application or other means, the anchor is applied to nodes for this periodically estimated location, possibly updating the node(s) pose in the scene graph when the marker moves. A combination of markers may be defined and used to estimate an anchor position. A list of candidate markers may be provided, and the anchor's pose may be estimated when one of these markers is detected (and its pose estimated), or when all (or a given number of) markers are detected and their pose estimated (bringing robustness or accuracy to the final anchor pose estimation). In case a combination of markers (aggregation) is used to estimate an anchor's location, the relative layout between these markers is provided. One of these markers is defined as the reference marker of that combination (e.g. the first provided marker) and the relative poses of all other markers may be used at the time of anchor's pose estimation. The final anchor position is given relatively to this reference marker.

In an embodiment, a minimum space around a marker may be required to anchor the item and to estimate its pose. This information may be defined as a bounding cube (for instance in meters) or a bounding sphere for instance. This may be used to manage multiple detection of an item, for example when the item is defined by a semantic description.

A user-based trigger is related to the user behavior and may, for example, be:
Input user interaction (ex: user's tap gesture, or user's vocal command, or user's gaze direction kept unchanged for a specific duration, user picking or moving an object of the real or virtual environment, etc.);
Position of the user within a given region (ex: proximity to a given object, located in a building or a room);
View of the user corresponding to a given direction or containing a given spatial point;

An external trigger is based on information provided by an external application or service, like, for example:
Alert/Information from a connected object (ex: temperature is above a threshold);
Notification from the current application (ex: collision detected);
Notification from another application/service (ex: reception of a text message or weather);
Time of the day;
Elapsed time since the launch of a given media (part of the scene description);
Elapsed time since the processing of the scene description (i.e. duration of use of that scene description);

A trigger is an information element comprising descriptors describing the nature of the trigger (related to the types of sensors needed for its activation) and every parameter required for the detection of its particular occurrence. An additional descriptor may indicate whether the action should be continued once the trigger is no longer activated.

In an embodiment, some types of triggers may comprise a descriptor describing limit conditions, that are conditions under which the activation of the trigger become probable. For example, a time range [9:00 am, 10:00 am] may have a limit condition set to 8:55 am indicating that the trigger will soon be activated. A limit condition may be used to load media content items linked to a node of the scene graph describing a virtual object only when the triggers are about to be activated. In this embodiment, media content items of virtual objects are loaded, decoded, prepared for rendering and buffered only when it is probable that they will be used. This saves memory and processing resources by processing and storing only the media content items that have a chance to be concerned by an action of an anchor.

In another example, considering a node N2 linked to an anchor defining a spatial trigger TRs, defining a threshold distance criteria TDc between two objects. For instance, TDc represents a minimum distance Dm between two objects described by two nodes N3 and N4. When, for any reason, the distance between the two objects becomes lower than Dm, the trigger is activated and the actions are applied to node N2. Trigger TRs may comprise a descriptor describing a limit condition that can be a distance Dd greater than Dm or a percentage p>1.0 (Dd=p*Dm). When the observed distance between the two objects described by N3 and N4 becomes lower than Dd, the media content items linked to N2 are loaded, decoded, prepared for rendering and buffered. Reciprocally, when the limit conditions are no longer satisfied, the media content items are unloaded from memory. In this example, the media content items linked to N2 are unloaded when the observed distance between the two objects described by N3 and N4 is greater than Dd.

Respectively, in case the probability of a trigger's activation became low (in the spatial trigger example, the user's is progressively moving away from a node that would be activated only when that user's is very close to it), then the related media(s), activated connection may be unloaded and/or released to avoid wasting storage or connectivity resources.

### Actions

An action may be:
the launch of a media processing: rendering video, playing a sound, rendering haptic feedback, or displaying virtual content item;
the stop or pause of a media processing;
the modification of the scene description (its description may be updated dynamically to reflect the wanted changes like moving object, new/disappearing object, etc.) amending the scene graph and/or the anchors; The anchoring may change the location (pose, orientation) of a node alone or of a node plus its children nodes (in a hierarchically representation of a medias). Parts of the scene (branch of nodes in hierarchical representation) may be duplicated. The rendering of some nodes (or branch of nodes) may be hide until some triggers and related conditions are met.
establishing a network connection giving access to the media content;
a distant notification
a request for some scene description update (could be a local request to the user's application, or to a distant server using a network connection, or other).

An action is an information element comprising descriptors describing the nature of the action (related to the types of rendering devices (i.e. displays, speakers, vibrators, heat, etc.) needed for its performance) and every parameter required for its particular occurrence. Additional descriptors may indicate the way the media has to be rendered. Some descriptors may depend on the media type:
3D content: pose and scale (can be defined with respect to the trigger);
Audio: volume, length, loop;
Haptics: location, type, intensity;
Delay before launching the action;
Delay before the action is considered obsolete (and ignored);

For these descriptors, default values may be indicated or defined in a memory of the AR system.

According to the present principles, an AR scene description as described above may be loaded from a memory or from a network by an AR system comprising at least an AR processing engine equipped with sensors.

In an embodiment, an anchor may comprise no action. The actions of the anchor may be determined, by default by the nature of the triggers. For example, if the nature of the trigger is a marker detection, then actions are, by default, a placement action. In this embodiment, the default actions for a type of trigger are stored in a memory of the AR processing engine.

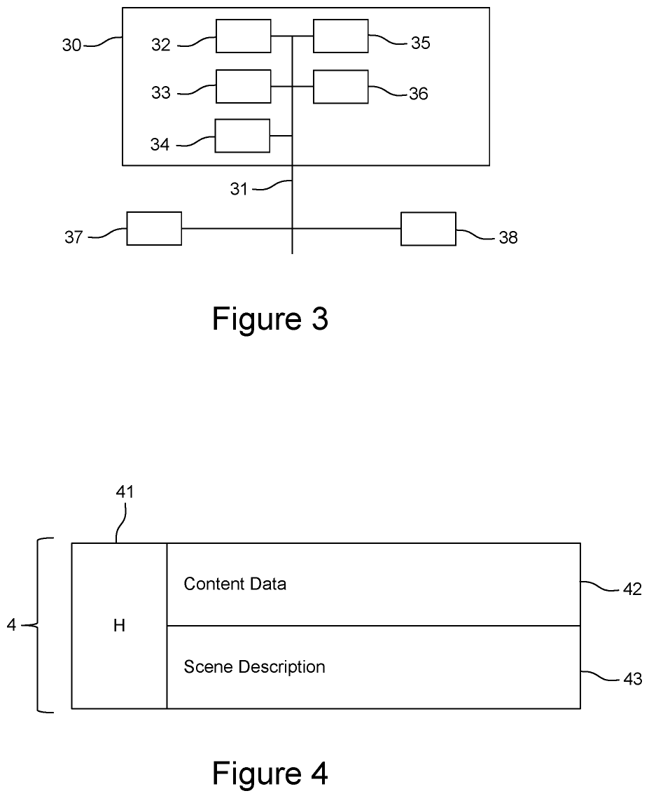

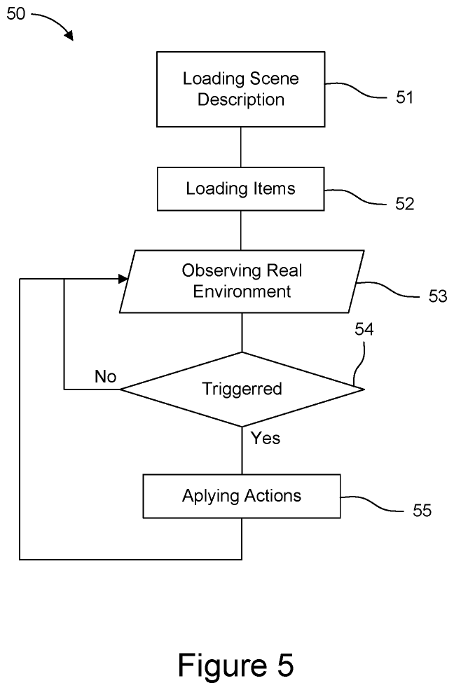

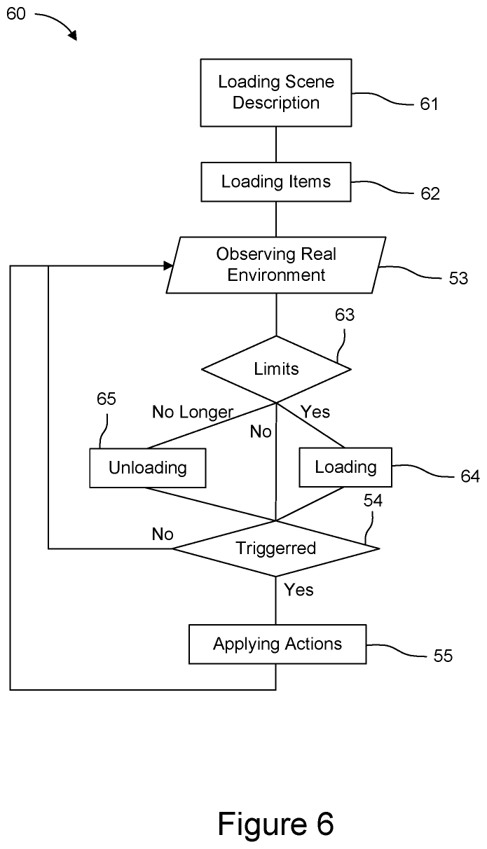

FIG. 3 shows an example architecture of an AR processing engine 30 which may be configured to implement a method described in relation with FIGS. 5 and 6. A device according to the architecture of FIG. 3 is linked with other devices via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply (not represented in FIG. 3), e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Device 30 is linked, for example via bus 31 to a set of sensors 37 and to a set of rendering devices 38. Sensors 37 may be, for example, cameras, microphones, temperature sensors, Inertial Measurement Units, GPS, hygrometry sensors, IR or UV light sensors or wind sensors. Rendering devices 38 may be, for example, displays, speakers, vibrators, heat, fan, etc.

In accordance with examples, the device 30 is configured to implement a method described in relation with FIGS. 5 and 6, and belongs to a set comprising:
a mobile device;
a communication device;
a game device;
a tablet (or tablet computer);
a laptop;
a still picture camera;
a video camera.

FIG. 4 shows an example of an embodiment of the syntax of a data stream encoding an augmented reality scene description according to the present principles. FIG. 4 shows an example structure 4 of an AR scene description. The structure consists in a container which organizes the stream in independent elements of syntax. The structure may comprise a header part 41 which is a set of data common to every syntax element of the stream. For example, the header part comprises some of metadata about syntax elements, describing the nature and the role of each of them. The structure also comprises a payload comprising an element of syntax 42 and an element of syntax 43. Syntax element 42 comprises data representative of the media content items describes in the nodes of the scene graph related to virtual elements. Images, meshes and other raw data may have been compressed according to a compression method. Element of syntax 43 is a part of the payload of the data stream and comprises data encoding the scene description as described in relation to FIG. 2.

FIG. 5 illustrates a method 50 for rendering an augmented reality scene according to a first embodiment of the present principles. At step 51, a scene description is obtained. According to the present principles, the scene description comprises a scene graph linking nodes, a node is a description of a real object or a description of a virtual object. Nodes describing virtual objects may be linked to media content items. Nodes of the scene graph may also describe relationships between other nodes. The scene description also comprises anchors. Anchors comprise at least a trigger that describes under what conditions the anchor is activated and at least an action. A node of the scene graph may be associated with one or several anchors. In the first embodiment of the present principles, at step 52, every media content item linked to nodes of the scene graph is loaded, prepared for rendering and buffered. At step 53, the augmented reality system observes the real environment thanks to a set of sensors of various types. At step 54, the augmented reality system analyzes the input from the sensors to verify if conditions described by triggers of the anchors are satisfied. If so, the satisfied trigger is activated and, step 55 is performed, otherwise, steps 53 and 54 are iterated. The processing engine checks the realization of the triggers listed in the scene description based on user's inputs and any application information involved in the scene rendering (time, etc.) and refreshes that checking conditions when a scene description is updated. If an anchor comprises several triggers, the anchor may comprise a descriptor to order the triggers and checked them by increasing cost (in terms of processing resources, for instance). For example, if the anchor comprises both a time range and an object detection, the time range is checked first (because it is an easy and quick check) and the object detection is tested only when the time range conditions are met. At step 55, the actions of the anchor of the activated trigger are applied to the nodes of the scene graph associated with this anchor. As described in relation to FIG. 2, an action may, for example, start, pause or stop playing a buffered media content item, or modify the scene description or communicate with a remote device. The anchor may comprise descriptors to indicate when and under which conditions an action has to be stopped or continued.

FIG. 6 illustrates a method 60 for rendering an augmented reality scene according to a second embodiment of the present principles. At step 61, a scene description is obtained. In this second embodiment, at least one trigger of the anchors of the scene description comprises a descriptor indicating a limit condition as described in relation to FIG. 2. At step 62, media content items liked to nodes that are associated with anchors the triggers of have no limit conditions are loaded. The media content items linked to nodes associated with an anchor with limit conditions are not loaded. Then, at step 53, the system starts observing the real environment by analyzing the inputs from its sensors. At step 63, if limit conditions of a trigger of an anchor are met, then media content items linked to nodes associated with the anchor are loaded at step 64. If limit conditions of a trigger of an anchor are no longer met, then data relative to the media content items linked to nodes associated with the anchor are unloaded from memory at step 65. In a variant, the trigger of the anchor comprises a descriptor indicating that the data relative to the loaded media content items have to be kept in memory and step 65 is skipped. If no limit condition is met or no longer met, step 54 is performed. Then at step 54, the augmented reality system analyzes the input from the sensors to verify if conditions described by triggers of the anchors are satisfied. If so, the satisfied trigger is activated and, step 55 is performed, otherwise, step 53 is iterated.

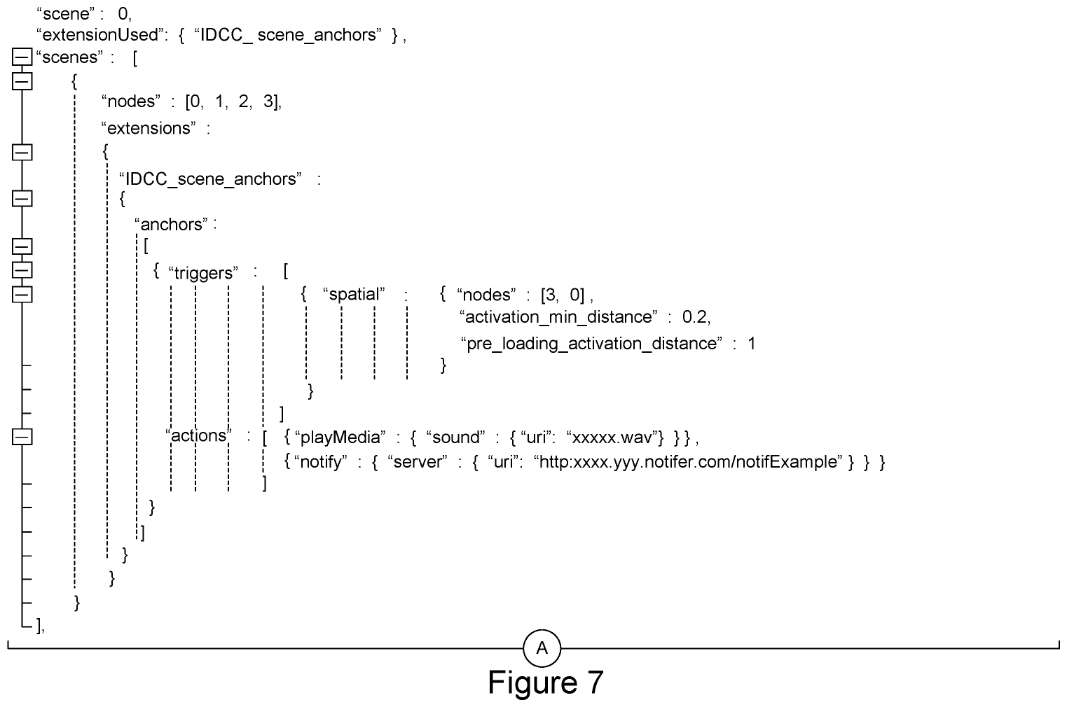

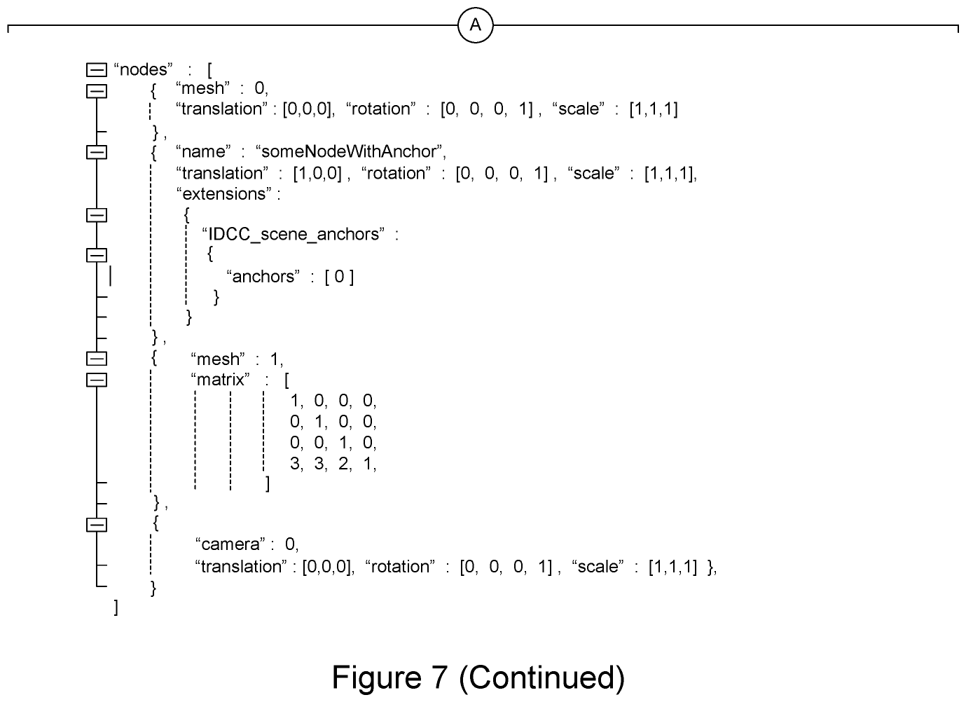

FIG. 7 shows an example scene description in a first format according to the present principles. In this example format, the anchors are described in an indexed list. Each anchor comprises the description of its triggers and actions. The nodes associated with an anchor comprise a descriptor with the index of the associated anchor.

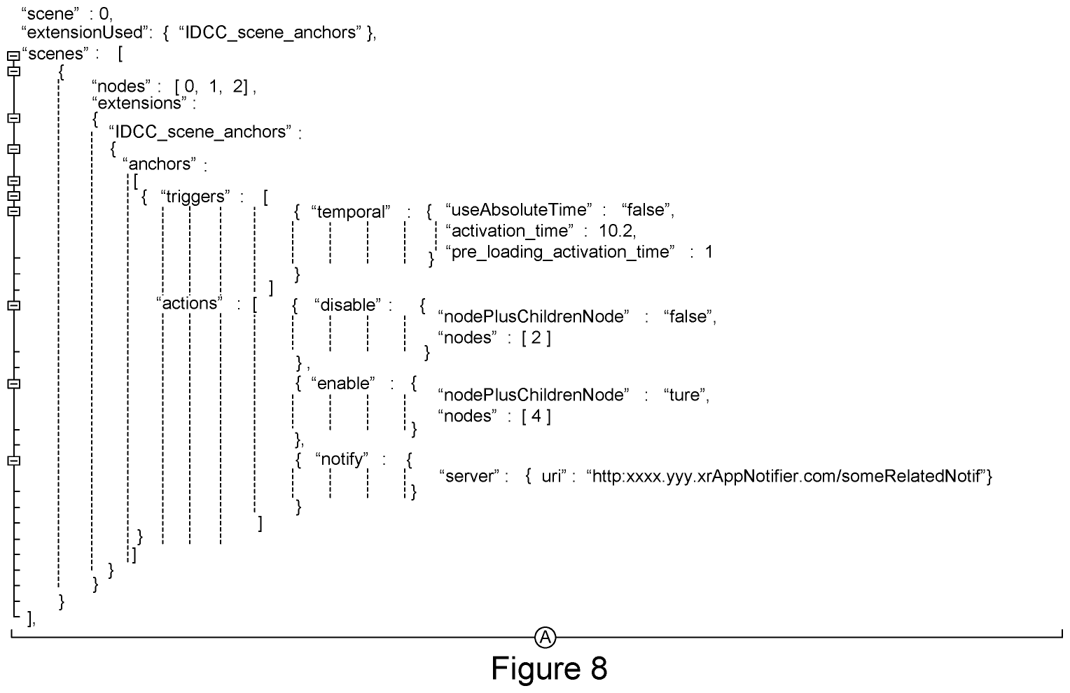

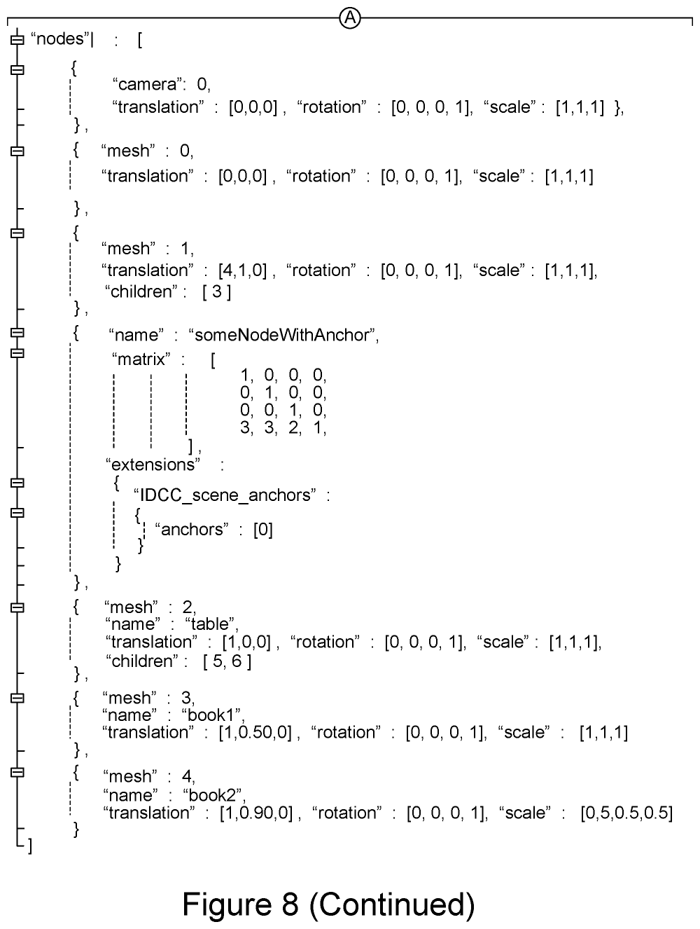

FIG. 8 shows another example scene description in the first format according to the present principles.

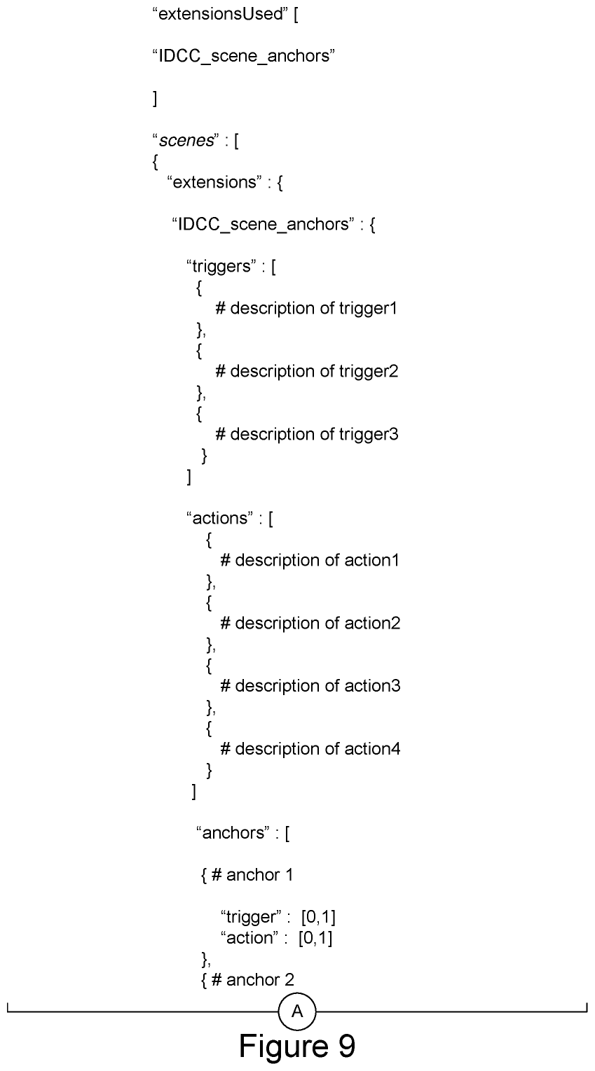

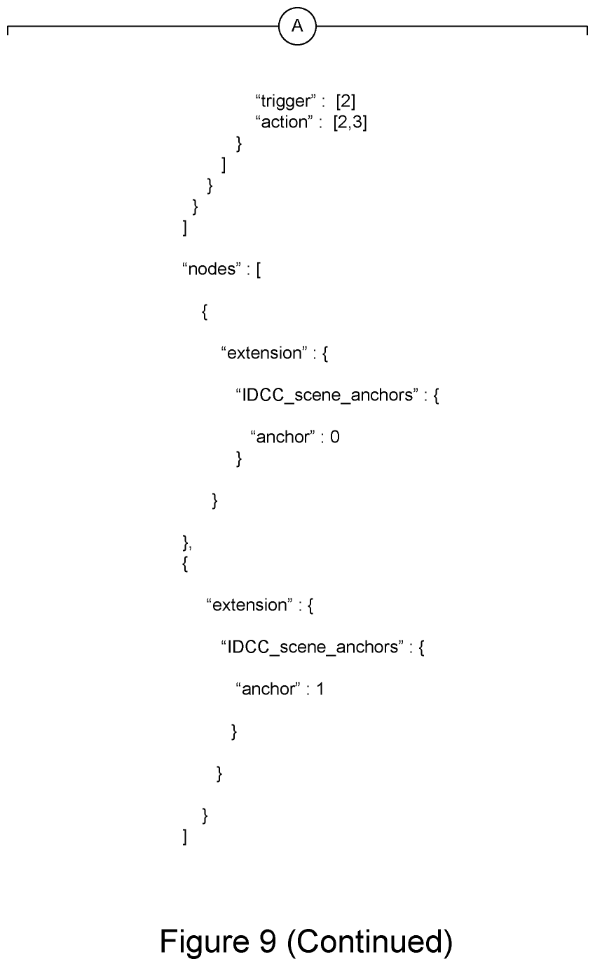

FIG. 9 shows an example scene description in a second format according to the present principles. In this format, the triggers and actions are described in two indexed lists. The anchors are described in a third indexed list and comprises the indices (in the first list) of the triggers and the indices (in the second list) of the actions of the anchor. The nodes associated with an anchor comprise a descriptor with the index (in the third list) of the associated anchor.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

### Examples of Usage

1. The content provider might know in advance what the anchor looks like (a 2D anchor image or 3D anchor model). In that case, the image or model will be put into the scene description and delivered (with scene description and renderable volumetric content or other renderable content) to the client. The client will look for that anchor and use it as a trigger to render the associated content, and to place the associated content into the scene.

a. Example: Coke can triggers playing of visual or audio advertisement, or ‘ad jingle’ song.

b. Example: Art museum. The content provider knows the environment in advance, and the anchors might be different images of the art in the museum. Detection of the anchors would trigger interactive visual/volumetric experience when a painting or a sculpture comes into the user's view.

c. Example: User's living room. The environment may be simply known from past client viewings of the same environment, e.g. the content creator may know what the user's living room looks like because the user is always there wearing the mixed reality headset, and so a variety of useful anchors from the known environment would be available for use in the scene description. (The available anchors might be determined by the user's client and reported as anchors to the server. Or the client might just send scans of the environment periodically to the server, and the appropriate anchors could be determined on the server side).

2. The content provider might know only a general (or “fuzzy”) description of what should trigger placement of the content, e.g. if the client detects OBJECT X or ENVIRONMENTAL PROPERTY Y, then that detection would trigger placement of the content. No exact 2D image or 3D model is available, but some semantic description of the triggering object or environmental property would be put into the ‘scene description anchor’ description and used by the client with some object or environmental property detection algorithm.

a. Example: Enhanced Pokémon Go application. Server provides volumetric representations of each virtual Pokémon, and the associated scene description associates each Pokémon to some semantic description of where the Pokémon would best be placed. For example:

i. Anchor=Tree for Pidgeot.

ii. Anchor=River or Lake (or Water) for Gyrados

iii. Anchor=Bed or Couch for Snorlax

b. Example: Virtual refrigerator magnets app. Content simulates photos or magnets attached to front door of a refrigerator. Anchor is to detect a refrigerator in the environment, and then anchor the content to the front door of the refrigerator. This is an interesting example since the description is semantic (we don't have a specific image of the refrigerator we are looking for), but still the content would need to be anchored to a specific area of the detected refrigerator (e.g. top half of the door of the refrigerator, around eye level. You wouldn't want the content placed on the sides or back of the refrigerator, and also the content should not be placed down near the floor).

3. Multiple users in the same environment. This is an interesting example because the anchors in the scene description enable the virtual content to be placed consistently (i.e. aligned to the same environmental anchors) for the multiple users, so they can interact consistently with the content. It is straightforward if the environment is known in advance. However, the scenario becomes more interesting if the environment is not known in advance.

a. Example: Virtual Game of Chess

i. User 1 receives scene description with chess board and objects for the pieces, and in the initial description the anchor is semantic—it gives requirements for a flat surface above the floor, such as a table or countertop.

ii. User 1's client detects a suitable surface (coffee table in real local environment) and places the content so User 1 can begin the experience (The chess board is placed on the coffee table with white pieces facing User 1).

iii. User 1's client detects anchor features suitable for anchoring the chess board to the coffee table. This may use textures or corners/edges of the table, depending on what provides enough detail to use as the anchor. Client uses these features ongoing to maintain alignment of the chess board to the table.

iv. User 1's client reports the determined anchors back to the server or content provider, along with details of how the content is aligned relative to the determined anchor content. (Anchors may be relayed as 2D image or 3D model, depending on client capabilities).

v. User 2 joins the game, retrieves content and scene description from the server. Now the scene description is updated to include more concrete anchors based on what user 1 client provided to the server (e.g. 2D image or 3D model of coffee table anchor(s), along with relative alignment info to describe how the content—that is the chessboard and pieces—would be aligned relative to the anchors).

User 2's client renders the chessboard, using the anchors and alignment info provided by the server. User 2's client is thus able to place the content in the same real-world location/orientation as User 1's client, and the two may play the game with a consistent view of the virtual content anchored to the real world

1. A method for rendering an augmented reality scene for a user in a real environment, the method comprising:
obtaining a description of the augmented reality scene, the description comprising:
a scene graph; and
one or more anchors, wherein each anchor of the one or more anchors is associated with one or more nodes of the scene graph and comprises:
a trigger, wherein the trigger is a description of at least one condition; wherein the at least one condition is a detection of a visual or audio or environment-based marker or property, and wherein the trigger is activated when a condition of the at least one condition is detected in the real environment; and
an action, wherein the action comprises a description of a process to be performed by an augmented reality engine;
observing the augmented reality scene;
on condition that the trigger of one of the one anchor or more anchors is activated, applying the action of the one anchor of the one or more anchors to the one or more nodes associated with the one anchor of the one or more anchors; and
loading one or more media content items linked to at least one of the one or more nodes.

2. The method of claim 1, wherein the trigger of one of the one or more anchors comprises one or more limit conditions and wherein the media content items are linked to the at least one of the one or more nodes and loaded only when the one or more limit conditions are observed in the augmented reality scene.

3. The method of claim 2, further comprising, when the one or more limit conditions are no longer observed in the augmented reality scene, unloading the media content items linked to the at least one of the one or more nodes.

4. The method of claim 1, wherein the trigger of one of the one or more anchors comprises a descriptor indicating whether the action of the one or more anchors continues once the trigger is no longer activated.

5. The method of claim 1, wherein the trigger of one of the one or more anchors comprises a description of at least two conditions and a descriptor indicating how to combine the at least two conditions.

6. The method of claim 1, wherein the at least one condition is a member of a group of conditions comprising detection of:
one or more visual 2D markers, one or more visual 3D markers, one or more visual signatures, one or more visual geometric properties, one or more visual semantic properties,
one or more audio markers, one or more audio properties,
one or more temperature conditions, one or more movement of real or virtual objects, one or more hygrometry conditions, one or more lighting changes, and one or more wind conditions.

7. The method of claim 1, wherein the trigger of one of the one or more anchors relies on a detection of an object in the real environment, and wherein the trigger is associated with a model of the object or with a semantic description of the object.

8. The method of claim 1, wherein the action of one of the one or more anchors is a member of a group of actions comprising:
playing, pausing or stopping a media content item;
modifying the description of the augmented reality scene; and
connecting a remote device or service.

9. (canceled)

10. A device for rendering an augmented reality scene for a user in a real environment, the device comprising a memory associated with a processor configured for:
obtaining a description of the augmented reality scene, the description comprising:
a scene graph; and
one or more anchors, wherein each anchor of the one or more anchors is associated with one or more nodes of the scene graph and comprises:
a trigger, wherein the trigger is a description of at least one condition; wherein the at least one condition is a detection of a visual or audio or environment-based marker or property, and wherein the trigger is activated when a condition of the at least one condition is detected in the real environment; and
an action, wherein the action comprises a description of a process to be performed by an augmented reality engine;
observing the augmented reality scene; and
on condition that the trigger of one anchor of the one or more anchors is activated, applying the action of the one anchor of the one or more anchors to the one or more nodes associated with the one anchor of the one or more anchors; and
loading a part of media content items being linked to the nodes of the scene graph.

11. The device of claim 10, wherein the trigger of one of the one or more anchors comprises one or more limit conditions and wherein the media content items are linked to the one of the one or more nodes and loaded only when the one or more limit conditions are observed in the augmented reality scene.

12. The device of claim 11, wherein the processor is further configured for, when the one or more limit conditions are no longer observed in the augmented reality scene, unloading the media content items linked to the at least one of the one or more nodes.

13. The device of claim 10, wherein the trigger of one of the one or more anchors comprises a descriptor indicating whether the action of the one or more anchors continues once the trigger is no longer activated.

14. The device of claim 10, wherein a trigger of one of the one or more anchors comprises a description of at least two conditions and a descriptor indicating how to combine the at least two conditions.

15. The device of claim 10, wherein the at least one condition is a member of a group of conditions comprising detection of:
one or more visual 2D markers, one or more visual 3D markers, one or more visual signatures, one or more visual geometric properties, one or more visual semantic properties,
one or more audio markers, one or more audio properties,
one or more temperature conditions, one or more movement of real or virtual objects, one or more hygrometry conditions, one or more lighting changes, and one or more wind conditions.

16. The device of claim 10, wherein the trigger of one of the one or more anchors relies on a detection of an object in the real environment and wherein the trigger is associated with a model of the object or with a semantic description of the object.

17. The device of claim 10, wherein the at least an action of one of the one or more anchors is a member of a group of actions comprising:
playing, pausing or stopping a media content item;
modifying the description of the augmented reality scene; and
connecting a remote device or service.

18. (canceled)

19. A non-transitory computer-readable medium carrying data representative of an augmented reality scene and comprising:
a description of the augmented reality scene, the description comprising:
a scene graph; and
one or more anchors, wherein each anchor of the one or more anchors is associated with one or more nodes of the scene graph and comprises:
a trigger, wherein the trigger is a description of at least one condition; wherein the at least one condition is a detection of a visual or audio or environment-based marker or property, and wherein the trigger is activated when a condition of the at least one condition is detected in a real environment; and
an action, wherein the action comprises a description of process to be performed by an augmented reality engine; and
media content items linked to the nodes of the scene graph.

20. (canceled)

21. The non-transitory computer-readable medium of claim 19, wherein the trigger relies on a detection of an object in the real environment and wherein the trigger is associated with a model of the object or with a semantic description of the object.
